(19) United States
(12) Patent Application Publication
(10) Pub. No.: US 2023/0066532 A1
(43) Pub. Date: Mar. 2, 2023

(54) PROTECTIVE GARMENT HAVING ENHANCED EVAPORATIVE HEAT TRANSFER

(71) Applicant: Fire-Dex, LLC, Medina, OH (US)

(72) Inventor: Matthew L. Colatruglio, Medina, OH (US)

(21) Appl. No.: 17/929,231

(22) Filed: Sep. 1, 2022

Related U.S. Application Data
(60) Provisional application No. 63/239,450, filed on Sep. 1, 2021.

(51) Int. Cl. A41D 27/28; A41D 31/06; A41D 31/08; A41D 13/00; A41D 31/102

(52) U.S. Cl. CPC A41D 27/28; A41D 31/065; A41D 31/085; A41D 13/0002; A41D 31/102

(57) ABSTRACT

A protective garment comprises a thermal liner, a moisture barrier, and an outer shell. The protective garment includes one or more transferal portions located at predetermined areas to enhance evaporative heat transfer. In some embodiments, the transferal portions of the protective garment have Resistance to Evaporation of a Textile (Ret) of less than 20 m2 Pa/W.

### CROSS-REFERENCE TO RELATED APPLICATION

This application claims the benefit of U.S. Provisional Patent Application Ser. No. 63/239,450, filed Sep. 1, 2021, the entirety of which is herein incorporated by reference.

### FIELD

The present disclosure relates to a protective garment and, more specifically, to a protective garment having enhanced evaporative heat transfer.

### BACKGROUND

Conventional protective garments are designed to shield a wearer from a variety of environmental hazards, and firefighting turnout gear is representative of such garments. The firefighting turnout gear includes coats, pants, coveralls, helmets, gloves, footwear, and interface components. Typically, the coats and pants each comprises an outer shell, a moisture barrier located beneath the outer shell, a thermal liner located beneath the moisture barrier.

The outer shell typically is constructed of an abrasion-, flame- and heat-resistant material such as a woven aramid material, typically NOMEX® or KEVLAR® (all are trademarks of E. I. DuPont de Nemours & Co., Inc.) or a polybenzamidazole, a polybenzoxazole, or an oxidized polyacrylonitrile (OPAN) fiber material. The moisture barrier typically includes a semipermeable membrane layer which is moisture vapor permeable but impermeable to liquid moisture, such as CROSSTECH® (a trademark of W. L. Gore & Associates, Inc.) or STEDAIR® 4000 (a trademark of Stedfast Inc.). The membrane layer is bonded to a substrate of flame- and heat-resistant material, such as an aramid or PBI® material. Further, the thermal liner typically is constructed of a nonwoven fabric, usually spunlace, quilted to a facecloth.

As mentioned, the moisture barrier is positioned between the thermal liner and the outer shell. This is done, in part, to prevent an insulating material of the thermal liner from absorbing an excessive amount of liquid moisture from the ambient environment, for example from fire hose spray or rain, which undesirably increases the overall weight of the protective garment, and can reduce the thermal resistance characteristics due to a high thermal conductivity of liquid moisture compared to air, increasing risk of burn injury.

It is important to note that moisture may also find its way into the various layers of a garment via diffusion and condensation mechanisms. That is, moisture which may be initially localized to an inner or outer layer can move to other locations in the form of water vapor, and may condense in those locations under the appropriate conditions. This means that simply blocking the physical transport of liquid water may not be sufficient in all cases to ensure that the appropriate level of thermal protection is maintained.

Moisture within the various layers of the protective garment can also serve as a source for hazardous convective air movement. Upon heating, for example from hazardous radiant exposure from a fire, air and any moisture present within the layers of the protective garment will heat up. Air when laden with moisture can hold significant and hazardous amounts of heat energy, much more so than dry air. As this moisture-laden air expands and moves through the layers of the protective garment, it can pose serious risk of burn injury if it moves toward the body of the wearer.

The impact of this moisture within the protective garment layers can be highly unpredictable to the wearer of the protective garment. That is, the wearer, for example a firefighter, may be unable to foresee how much thermal protection has been compromised by moisture in the garment, and so may not be able to effectively adjust their actions to the new level of risk. Additionally, moisture in the protective garment can reduce the “alarm-time”, the time between when the wearer may begin to feel pain due to hazardous thermal exposure, and when they may experience a second-degree burn injury. This time between pain and burn (also known as escape time), is the critical time the wearer has to reduce thermal exposure before being severely burned. In many realistic end-use scenarios for wearers of such protective garments, even small differences such as a few lost seconds in time-to-burn and alarm-time can result in serious injury.

Furthermore, one of the most dangerous threats to firefighters is heat exhaustion, which could possibly result in death. The primary mechanism of a human body to prevent heat exhaustion and normalize core body temperature is to sweat (i.e. emit liquid moisture). Once the sweat on the skin evaporates into moisture vapor, it is able to carry heat away from the body. During active firefighting, the wearer produces immense amounts of liquid moisture and heat that must be transferred from the body in order to cool the wearer and prevent an overheated state. If the wearer experiences an overheated state and remains therein, the wearer may succumb to heat exhaustion which is the number one killer of firefighters today.

Accordingly, it would be desirable to develop a protective garment having enhanced evaporative heat transfer.

### SUMMARY

In concordance and agreement with the presently described subject matter, a protective garment having enhanced evaporative heat transfer, has surprisingly been discovered.

In one embodiment, a protective garment, comprises: an outer shell; and a thermal liner disposed adjacent the outer shell, wherein the protective garment includes at least one transferal portion configured to facilitate evaporative heat transfer therefrom.

As aspects of some embodiments, the at least one transferal portion is provided in at least one of an armpit, underarm gusset, side-panel, groin, side-knee, and rear knee area of the protective garment.

As aspects of some embodiments, at least a portion of the outer shell in the at least one transferal portion is produced from at least one of an aramid material, a polybenzamidazole material, a polybenzoxazole material, and an oxidized polyacrylonitrile (OPAN) material.

As aspects of some embodiments, at least a portion of the outer shell in the at least one transferal portion is produced from at least one of a meta-aramid material, a para-aramid material, and an oxidized polyacrylonitrile (OPAN) material.

As aspects of some embodiments, at least a portion of the outer shell in the at least one transferal portion is produced from a blend of meta-aramid fibers, para-aramid fibers, and oxidized polyacrylonitrile (OPAN) fibers.

As aspects of some embodiments, the protective garment further comprises a moisture barrier disposed between the outer shell and the thermal liner.

As aspects of some embodiments, the moisture barrier includes a semipermeable membrane.

As aspects of some embodiments, the thermal liner comprises a facecloth layer and at least one insulation layer.

As aspects of some embodiments, the facecloth layer is produced from at least one of an aramid material, a polybenzamidazole material, a polybenzoxazole material, and an oxidized polyacrylonitrile (OPAN) material.

As aspects of some embodiments, the at least one insulation layer is produced from at least one of a spunlace, a woven material, a nonwoven material, a stretch woven material, a knit material, a fleece material, and a laminate material.

As aspects of some embodiments, the at least one insulation layer is produced from at least one of a meta-aramid spunlace and a para-aramid spunlace.

As aspects of some embodiments, the at least one transferal portion has a Resistance to Evaporation of a Textile (Ret) of less than 20 m2 Pa/W.

In another embodiment, a protective garment, comprises: an outer shell; and a thermal liner disposed adjacent the outer shell, wherein the protective garment includes at least one transferal portion having a Resistance to Evaporation of a Textile (Ret) of less than 20 m2 Pa/W.

In yet another embodiment, a method of producing a protective garment, comprises the steps of: providing a thermal liner and an outer shell; and arranging the thermal liner and the outer shell together to produce the protective garment, wherein the protective garment includes at least one transferal portion configured to facilitate evaporative heat transfer therefrom.

As aspects of some embodiments, the method further comprises the steps of: providing a moisture barrier; and arranging the moisture barrier between the thermal liner and the outer shell.

### BRIEF DESCRIPTION OF THE DRAWINGS

The above, as well as other advantages of the present disclosure, will become readily apparent to those skilled in the art from the following detailed description of a preferred embodiment when considered in the light of the accompanying drawings.

FIG. 1 is a front elevational view of a protective garment including a plurality of transferal portions according to an embodiment of the present disclosure;

FIG. 2 is a rear elevational view of the protective garment of FIG. 1, showing the transferal portions;

FIG. 3 is a front elevational view of a protective garment including a plurality of transferal portions according to another embodiment of the present disclosure;

FIG. 4 is a fragmentary enlarged view of a portion of the protective garment of FIG. 3, partially showing one of transferal portions; and

FIG. 5 is a cross-sectional view of one of the transferal portions shown in FIGS. 1-4.

### DETAILED DESCRIPTION

The following detailed description and appended drawings describe and illustrate various exemplary embodiments of the present disclosure. The description and drawings serve to enable one skilled in the art to make and use the present disclosure, and are not intended to limit the scope of the present disclosure in any manner. In respect of the methods disclosed, the steps presented are exemplary in nature, and thus, the order of the steps is not necessary or critical.

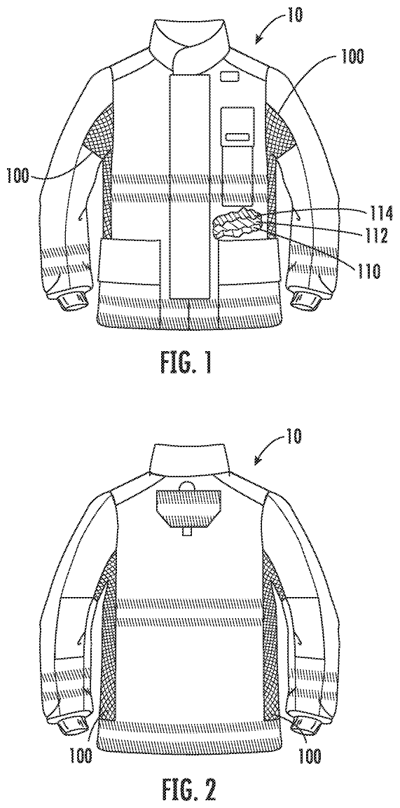

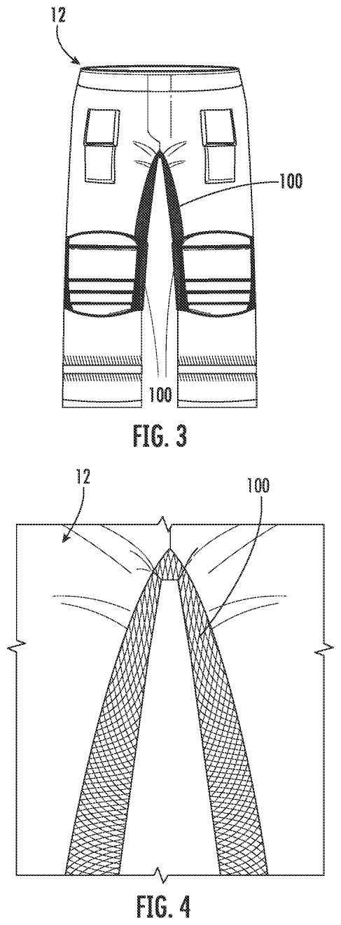

FIGS. 1-3 illustrate exemplary protective garments 10, 12 according to the present disclosure. More particularly, FIGS. 1 and 2 illustrate a firefighter turnout coat representative of the protective garment 10 and FIG. 3 illustrates a firefighter turnout pant representative of the protective garment 12, both of which can be donned by firefighter personnel when exposed to flames and extreme heat. It is noted that, although a firefighter turnout coat and pant are shown in FIGS. 1-3 and described herein, the present disclosure pertains to protective garments 10, 12 generally. Accordingly, the identification of firefighter turnout gear is not intended to limit the scope of the disclosure. The protective garments 10, 12 may be other types of protective garments which include, but are not limited to, suits for industrial workers (including, for example, arc flash apparel), wildland's firefighters, race car drivers, airplane pilots, military personnel, and the like.

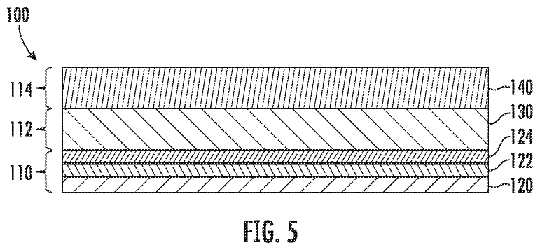

As depicted, the protective garments 10, 12 each may include at least one transferal portion 100 to enhance evaporative heat transfer. An enlarged view of a part of the protective garment 12 including one of the transferal portions 100 is shown in FIG. 4. In certain embodiments, the transferal portion 100 may have a multi-layer construction. As best seen in FIG. 5, the transferal portion 100 generally comprises a thermal liner 110 that forms an interior surface (i.e., a surface that contacts the wearer) of the protective garment 10, a moisture barrier 112 that forms an intermediate layer of the protective garment 10, and an outer shell 114 that forms an exterior surface of the protective garment 10. When integrated the thermal liner 110, the moisture barrier 112, and the outer shell 114 may be characterized as having a thermal protective performance (TPP per NFPA 1971) of at least 35.

The thermal liner 110 shown may, optionally, include a facecloth layer 120, a first insulation layer 122, and a second insulation layer 124, which may be quilted together. In alternative embodiments, however, the thermal liner 110 may only include one of the insulation layers 122, 124 used with or without the facecloth layer 120. When it is used, the facecloth layer 120 may be constructed of at least one material comprising flame resistant and/or moisture-wicking fibers or filaments made of, for example, at least one of an aramid (meta-aramid or para-aramid), polybenzimidazole, polybenzoxazole, melamine, cellulosics, flame resistant (FR) cellulosics, modacrylic, carbon, or the like, and blends thereof. In one embodiment, the facecloth layer 120 may be produced from at least one of a spunlace, a woven material, a nonwoven material, a stretch woven material, a knit material, a fleece material, and a laminate material, for example. The facecloth layer 120 may be, optionally, finished with a hydrophilic finish that draws perspiration off of the wearer, if desired.

Each of the insulation layer 122, 124 may comprise a material that includes one or more flame resistant fibers. The insulation layers 122, 124 may each comprise a single layer of nonwoven material, or two layers of nonwoven material, or multiple layers of nonwoven material. In one embodiment, at least one of the insulation layers 122, 124 may be produced from at least one of a spunlace, a woven material, a nonwoven material, a stretch woven material, a knit material, a fleece material, and a laminate material, for example. In other embodiments, the first insulation layer 122 may be produced from a blend of meta-aramid (e.g., Nomex™) and/or para-aramid (e.g., Kevlar™) spunlace and/or the second insulation layer 124 may be a fleece material produced from a blend of meta-aramid (e.g., Nomex™), para-aramid (e.g., Kevlar™), and/or anti-static fibers. In some instances, the flame resistant fibers may also be characterized as non-water absorbing fibers. Non-water absorbing fiber does not refer to the moisture regain of the fiber. Moisture regain, as used herein, refers to percentage of atmospheric moisture in a textile material brought into equilibrium with a standard atmosphere after partial drying, calculated as a percentage of the moisture-free weight. Instead, non-water absorbing fiber refers to the fibers ability, when placed in contact with liquid water, to swell, absorb, and retain that water.

It is understood that the facecloth layer 120 and/or the insulation layers 122, 124, collectively the thermal liner 110, may have any suitable thickness as desired.

The moisture barrier 112 may be constructed of a non-woven or woven flame resistant fabric 130 comprising flame resistant fibers made of, for example, aramid (meta- and/or para-aramid), polybenzimidazole, polybenzoxazole, melamine, or the like, and blends thereof. The moisture barrier typically includes a semipermeable membrane layer which is moisture vapor permeable but impermeable to liquid moisture, such as CROSSTECH® (a trademark of W. L. Gore & Associates, Inc.) or STEDAIR® 4000 (a trademark of Stedfast Inc.). The membrane layer is bonded to a substrate of flame- and heat-resistant material, such as an aramid or PBI® material. The moisture barrier 112 may be laminated with a water-impermeable layer of material (not depicted) such as, for instance, a layer of polytetrafluoroethylene (PTFE), expanded polytetrafluoroethylene (ePTFE), polyurethane (PU), urethane, and the like, or any combination thereof. When such an impermeable layer is provided, it usually is provided on the moisture barrier 112, so as to face the thermal liner 110. It is understood that the moisture barrier 112 may have any suitable thickness as desired.

The outer shell 114 is typically constructed of a heat and flame resistant material 140 that comprises flame resistant fibers made of, for example, at least one of aramid (meta- and/or para-aramid), polybenzamidazole, polybenzoxazole, oxidized polyacrylonitrile (OPAN), or the like, and blends thereof. The outer shell 114 may be treated with a water-resistant finish to prevent or reduce water absorption from the outside environment. In that the outer shell 114 forms an exterior surface of the protective garment 10, the outer shell 114 preferably is constructed so as to be flame resistant to protect the wearer against being burned in certain applications. In addition, the outer shell 114 preferably is strong so as to be resistant to tearing and abrasion during use in extreme environments.

In preferred embodiments, the outer shell 114 in the transferal portions 100 of the protective garments 10, 12, may be a woven and/or a stretch woven material comprising a blend of at least one aramid material and an oxidized polyacrylonitrile (OPAN) material. More preferably, the outer shell 114 in the transferal portions 100 of the protective garments 10, 12 may be produced from a blend of meta-aramid fibers (e.g., Nomex™), para-aramid fibers (e.g., Kevlar™), and oxidized polyacrylonitrile (OPAN). In a non-limiting example, the outer shell 114 in the transferal portions 100 of the protective garments 10, 12 is produced from about 22% meta-aramid fibers (e.g., Nomex™), about 60% para-aramid fibers (e.g., Kevlar™) and about 18% oxidized polyacrylonitrile (OPAN).

As identified above, the resistance to evaporative heat transfer of the outer shell 114 may be lessened by providing the transferal portions 100. As shown in FIGS. 1-4, the transferal portion 100 may be discretely-positioned and used in predetermined areas (e.g. armpit, underarm gusset, and side-panel areas of the protective garment 10 and groin and side and/or rear knee areas of the protective garment 12). In certain embodiments, the transferal portions 100 are positioned in the protective garments 10, 12 at locations adjacent parts of the wearer that are likely to produce liquid moisture (i.e., sweat). Therefore, the protective garments 10, 12 may be significantly improved without sacrificing pliability, processability, and the like. By using the transferal portions 100, it is possible to produce protective garments 10, 12 that optimize evaporative heat transfer to reduce heat stress of the wearer, while maximizing thermal protection.

As discussed herein, the protective garments 10, 12 may be firefighter turnout gear. Firefighter turnout gear must comply with the NFPA 1971 standards requiring a composite thermal protection performance (TPP) of >35 and a total heat loss (THL) >205. In the next standards of NFPA 1971, the Resistance to Evaporation of a Textile (Ret) test (ISO 11092) will become a requirement. The Ret test is a means to evaluate a resistance of a material or material set to evaporative heat transfer. Ret is conducted per ISO 11092, 1993 edition, and is expressed in m2 Pa/W. Higher Ret values indicate lower moisture vapor permeability and higher resistance to evaporative heat transfer, and thus, more heat trapped within the protective garments 10, 12 and subjected to the wearer. One such Ret test measures the resistance to evaporative heat transfer through a three-layer composite using a sweating guarded hot plate at 35 degrees Celsius and 40% relative humidity.

When the transferal portions 100 are integrated into the protective garments 10, 12, each of the protective garments 10, 12 of the present disclosure may achieve a Ret of less than 20 m2 Pa/W.

In certain preferred embodiments, the transferal portions 100 of the protective garments 10, 12, which comprise the thermal liner 110 having a facecloth layer produced from a meta-aramid fiber material and an insulation layer produced from aramid (meta- or para-) spunlace; the moisture barrier 112 produced from a semipermeable membrane CROSSTECH® material; and the outer shell 114 produced from a blend of aramid and oxidized polyacrylonitrile (OPAN) fiber materials, have a relative low Ret of about 19 m2 Pa/W or less.

In other preferred embodiments, the transferal portions 100 of the protective garments 10, 12, which comprise the thermal liner 110 having a facecloth layer produced from a meta-aramid fiber material and an insulation layer produced from aramid (meta- or para-) spunlace; the moisture barrier 112 produced from a semipermeable membrane STEDAIR® 4000 material; and the outer shell 114 produced from a blend of aramid and oxidized polyacrylonitrile (OPAN) fiber materials, have a relatively low Ret of about 15 m2 Pa/W or less.

Low Ret is particularly beneficial in areas of the protective garments 10, 12 that experience high amounts of heat and moisture. This is because the low Ret areas, provided by the transferal portions 100, efficiently move moisture vapor and heat; thus cooling down the firefighter and avoiding heat exhaustion. Incorporating low Ret transferal portions 100 into the protective garments 10, 12 will keep the wearer much cooler versus conventional garments that have a higher Ret, which increases a risk of heat exhaustion of the wearer.

Advantageously, the protective garments 10, 12 are desirably compliant with any associated NFPA standards, including but not limited to NFPA 1971 Standard 2007 edition, and with EN 469 Standard 2005 edition. By incorporating the transferal portions 100, which have relatively low Ret, into areas of the protective garments 10, 12 that experience high amounts of heat and moisture, the protective garments 10, 12 will be able to efficiently move heat away from the wearer via evaporation to lower core body temperature. Accordingly, each of the protective garments 10, 12 of the present disclosure balances the features of effectively preventing absorption of moisture from the wearer, as well as forcing wet, dangerously hot air out away from the wearer, while maintaining desired insulative properties found in a dry condition, even when challenged by hazardous thermal exposures.

From the foregoing description, one ordinarily skilled in the art can easily ascertain the essential characteristics of this present disclosure and, without departing from the spirit and scope thereof, can make various changes and modifications to the present disclosure to adapt it to various usages and conditions.

What is claimed is:

1. A protective garment, comprising:
an outer shell; and
a thermal liner disposed adjacent the outer shell, wherein the protective garment includes at least one transferal portion configured to facilitate evaporative heat transfer therefrom.

2. The protective garment of claim 1, wherein the at least one transferal portion is provided in at least one of an armpit, underarm gusset, side-panel, groin, side-knee, and rear knee area of the protective garment.

3. The protective garment of claim 1, wherein at least a portion of the outer shell in the at least one transferal portion is produced from at least one of an aramid material, a polybenzamidazole material, a polybenzoxazole material, and an oxidized polyacrylonitrile (OPAN) material.

4. The protective garment of claim 1, wherein at least a portion of the outer shell in the at least one transferal portion is produced from at least one of a meta-aramid material, a para-aramid material, and an oxidized polyacrylonitrile (OPAN) material.

5. The protective garment of claim 1, wherein at least a portion of the outer shell in the at least one transferal portion is produced from a blend of meta-aramid fibers, para-aramid fibers, and oxidized polyacrylonitrile (OPAN) fibers.

6. The protective garment of claim 1, further comprising a moisture barrier disposed between the outer shell and the thermal liner.

7. The protective garment of claim 6, wherein the moisture barrier includes a semipermeable membrane.

8. The protective garment of claim 1, wherein the thermal liner comprises a facecloth layer and at least one insulation layer.

9. The protective garment of claim 8, wherein the facecloth layer is produced from at least one of an aramid material, a polybenzamidazole material, a polybenzoxazole material, and an oxidized polyacrylonitrile (OPAN) material.

10. The protective garment of claim 8, wherein the at least one insulation layer is produced from at least one of a spunlace, a woven material, a nonwoven material, a stretch woven material, a knit material, a fleece material, and a laminate material.

11. The protective garment of claim 8, wherein the at least one insulation layer is produced from at least one of a meta-aramid spunlace and a para-aramid spunlace.

12. The protective garment of claim 1, wherein the at least one transferal portion has a Resistance to Evaporation of a Textile (Ret) of less than 20 m2 Pa/W.

13. A protective garment, comprising:
an outer shell; and
a thermal liner disposed adjacent the outer shell, wherein the protective garment includes at least one transferal portion having a Resistance to Evaporation of a Textile (Ret) of less than 20 m2 Pa/W.

14. The protective garment of claim 13, wherein at least a portion of the outer shell in the at least one transferal portion is produced from at least one of an aramid material, a polybenzamidazole material, a polybenzoxazole material, and an oxidized polyacrylonitrile (OPAN) material.

15. The protective garment of claim 13, wherein at least a portion of the outer shell in the at least one transferal portion is produced from at least one of a meta-aramid material, a para-aramid material, and an oxidized polyacrylonitrile (OPAN) material.

16. The protective garment of claim 13, wherein at least a portion of the outer shell in the at least one transferal portion is produced from a blend of meta-aramid fibers, para-aramid fibers, and oxidized polyacrylonitrile (OPAN) fibers.

17. A method of producing a protective garment, comprising the steps of:
providing a thermal liner and an outer shell; and
arranging the thermal liner and the outer shell together to produce the protective garment, wherein the protective garment includes at least one transferal portion configured to facilitate evaporative heat transfer therefrom.

18. The method of claim 17, further comprising the steps of:
providing a moisture barrier; and
arranging the moisture barrier between the thermal liner and the outer shell.

19. The method of claim 17, wherein the at least one transferal portion has a Resistance to Evaporation of a Textile (Ret) of less than 20 m2 Pa/W.

20. The method of claim 17, wherein at least a portion of the outer shell in the at least one transferal portion is produced from at least one of an aramid material, a polybenzamidazole material, a polybenzoxazole material, and an oxidized polyacrylonitrile (OPAN) material.
